(19) United States
(12) Patent Application Publication
(10) Pub. No.: US 2013/0062171 A1
(43) Pub. Date: Mar. 14, 2013

(54) COVER AND SWITCH USING THE SAME

(71) Applicants: Minoru KOBAYASHI, Okayama-shi (JP); Taiki KOYAMA, Okayama-shi (JP)

(72) Inventors: Minoru KOBAYASHI, Okayama-shi (JP); Taiki KOYAMA, Okayama-shi (JP)

(73) Assignee: OMRON CORPORATION

(21) Appl. No.: 13/552,420

(22) Filed: Jul. 18, 2012

(30) Foreign Application Priority Data
Sep. 12, 2011 (JP) 2011-198531

(51) Int. Cl. H01H 13/06

(52) U.S. Cl. 200/302.2

(57) ABSTRACT

A long-life cover is provided whose outer circumferential edge is not warped upward and not easily damaged even when an operation shaft is pushed down to a final position. Therefore, the cover is to cover the operation shaft protruding from a housing of an electric device and is operable in the axis direction. Particularly, the cover includes a tubular pressing portion to which a pressing force is applied by operating the operation shaft, and a tubular elastic deformation portion continuous to a lower edge of an outer circumference of the tubular pressing portion, the tubular elastic deformation portion being thinner than the tubular pressing portion.

### CROSS-REFERENCE TO RELATED APPLICATIONS

This application claims priority to Japanese Application No. 2011-198531, filed on Sep. 12, 2011, the entire contents of which are incorporated herein by reference.

### BACKGROUND

1. Technical Field

The present application relates to a water proof and/or dust proof cover for covering an outer circumferential surface of an operation shaft of a switch provided with the operation shaft operable in the axis direction such as a trigger switch, so as to prevent invasion of water, grit, and dust.

2. Related Art

Conventionally, as a cover, in order to cover an outer circumferential surface of an operation shaft so as to prevent invasion of grit and dust, for example, there is a dust cover to be installed to a movable portion of a limit switch, the dust cover for a limit switch for covering the entire movable portion including a main body of the limit switch, the dust cover having a zigzag portion with at least one peak or trough (refer to Japanese Unexamined Patent Publication No. 11-53979).

However, in the dust cover for the limit switch described above, as shown in FIG. 1 thereof, when a plunger is pushed down to a final position, an outer circumferential edge of a zigzag portion 4 is warped upward and comes out to the upper side of a top portion 5. Therefore, since the outer circumferential edge of the zigzag portion is easily worn out and damaged, there is a problem that durability is inferior and the life is short.

### SUMMARY

The present application has been devised to solve the problems described above, and an object thereof is to provide a long-life cover whose outer circumferential edge is not warped upward and not easily damaged even when an operation shaft is pushed down to a final position.

In accordance with one aspect of the present application, a cover for covering an operation shaft protruding from a housing of an electric device and being operable in an axis direction, includes a tubular pressing portion to which a pressing force is applied by operating the operation shaft, and a tubular elastic deformation portion continuous with a lower edge of an outer circumference of the tubular pressing portion, the tubular elastic deformation portion being thinner than the tubular pressing portion.

According to the present application, when the tubular pressing portion is pushed down, the thin tubular elastic deformation portion is firstly largely bent. Particularly, when the tubular pressing portion is pushed down, the thin tubular elastic deformation portion is bent inward so as to be covered by the tubular pressing portion. Therefore, an outer circumferential edge of the tubular pressing portion as in a conventional example is not warped upward and does not come out. As a result, since the outer circumferential edge of the tubular pressing portion is not easily worn out and not easily damaged, durability is improved, so that the long-life cover can be obtained.

According to an embodiment, an annular groove portion forming a thin portion which is the thinnest part of the cover may be provided along an edge on the side of the tubular elastic deformation portion in a region where the lower edge of the tubular pressing portion and an upper edge of the tubular elastic deformation portion are connected.

For example, an annular groove portion forming a thin portion which is the thinnest part of the cover may be provided along an edge on the side of the tubular elastic deformation portion placed on an inner surface in a region where the lower edge of the tubular pressing portion and an upper edge of the tubular elastic deformation portion are connected. Alternatively, an annular groove portion forming a thin portion which is the thinnest part of the cover may be provided along an edge on the side of the tubular elastic deformation portion placed on an outer circumferential surface in a region where the lower edge of the tubular pressing portion and an upper edge of the tubular elastic deformation portion are connected.

According to this embodiment, the further thinner thin portion is formed between the tubular pressing portion and the tubular elastic deformation portion. Therefore, when the tubular pressing portion is pushed down, the thinner thin portion is firstly elastically deformed, and then the tubular elastic deformation portion is deformed. Thus, a push-down operation can be smoothly performed, so that the cover with favorable operation feel can be obtained.

According to another embodiment, at least one annular cutout portion may be provided along an outer circumferential surface of the tubular elastic deformation portion. Alternatively, at least one annular cutout portion may be provided along an inner circumferential surface of the tubular elastic deformation portion.

According to this embodiment, a thin region is partially formed in the tubular elastic deformation portion by the annular cutout portion. Therefore, the tubular elastic deformation portion is easily bent along the annular cutout portion. Thus, the push-down operation can be smoothly performed, so that the cover with favorable operation feel can be obtained.

According to yet another embodiment, a plurality of thick tubular pressing portions formed into a substantially truncated cone and a plurality of thin tubular elastic deformation portions formed into a substantially reversed truncated cone, the tubular elastic deformation portions being continuous to lower edges of outer circumferences of the tubular pressing portions may be alternately provided in a zigzag shape.

According to this embodiment, when the tubular pressing portions are pushed down, the tubular elastic deformation portions placed on the lower side of the tubular pressing portions are bent inward, and the tubular pressing portions are directly piled on the tubular pressing portions on the lower side so as to be compactly and elastically deformed. As a result, there is an effect that the cover also applicable to an operation shaft having a large push-in amount can be obtained.

According to yet another embodiment, an operation hole from which a front end surface of the operation shaft is exposed may be provided in center of a front end surface of the tubular pressing portion.

According to this embodiment, the thick tubular pressing portion is pushed down via the front end surface of the operation shaft, and the thin tubular elastic deformation portion is bent inward. Thus, the long-life cover can be obtained.

It should be noted that the front end surface of the operation shaft is not always required to be exposed from the operation hole of the cover but the entire operation shaft may be covered by the cover.

In accordance with another aspect of the present application, a switch includes an operation shaft protruding from a housing and being operable in an axis direction, and a cover for covering the operation shaft, wherein the cover includes a tubular pressing portion to which a pressing force is applied by operating the operation shaft, and a tubular elastic deformation portion continuous to a lower edge of an outer circumference of the tubular pressing portion, the tubular elastic deformation portion being thinner than the tubular pressing portion.

With the switch according to the present application, when the tubular pressing portion is pushed down, the thin tubular elastic deformation portion is firstly largely bent. Particularly, when the tubular pressing portion is pushed down, the thin tubular elastic deformation portion is bent inward so as to be covered by the tubular pressing portion. Therefore, the outer circumferential edge of the tubular pressing portion as in the conventional example is not warped upward and does not come out. As a result, since the outer circumferential edge of the tubular pressing portion is not easily worn out and not easily damaged, durability is improved. Thus, there is an effect that the switch including the long-life cover can be obtained.

### BRIEF DESCRIPTION OF THE DRAWINGS

FIG. 1A is a perspective view showing a trigger switch to which a cover is applied, and FIG. 1B is a perspective view showing the cover for the trigger switch shown in FIG. 1A;

FIGS. 2A and 2B are perspective views showing states before and after the trigger switch shown in FIG. 1A is operated;

FIG. 3A is a front view showing the cover shown in FIG. 1B, and FIG. 3B is a sectional view taken along line B-B of FIG. 3A;

FIGS. 4A and 4B are a perspective view and a front view showing a state that the cover shown in FIG. 1B is elastically deformed, and FIG. 4C is a sectional view taken along line C-C of FIG. 4B;

FIGS. 5A and 5B are a perspective view and a front view showing a second embodiment of the cover, and FIG. 5C is a sectional view taken along line C-C of FIG. 5B;

FIGS. 6A and 6B are a perspective view and a front view showing a third embodiment of the cover, and FIG. 6C is a sectional view taken along line C-C of FIG. 6B; and

FIGS. 7A and 7B are a perspective view and a front view showing a fourth embodiment of the cover, and FIG. 7C is a sectional view taken along line C-C of FIG. 7B.

### DETAILED DESCRIPTION

In embodiments of a cover, cases where the present cover is applied to a dust proof cover to be installed to a trigger switch will be described.

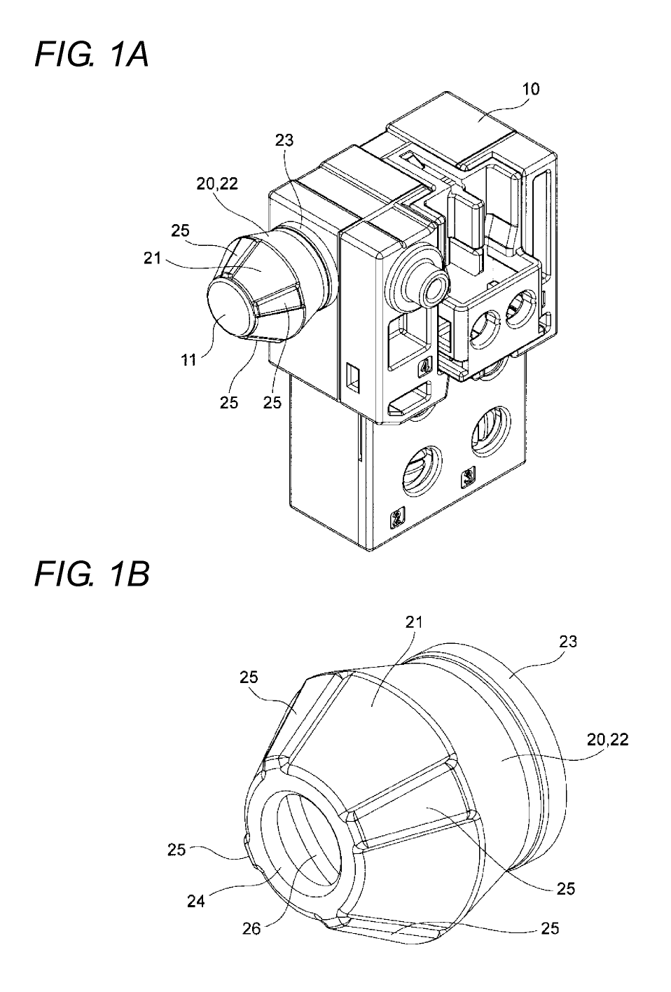

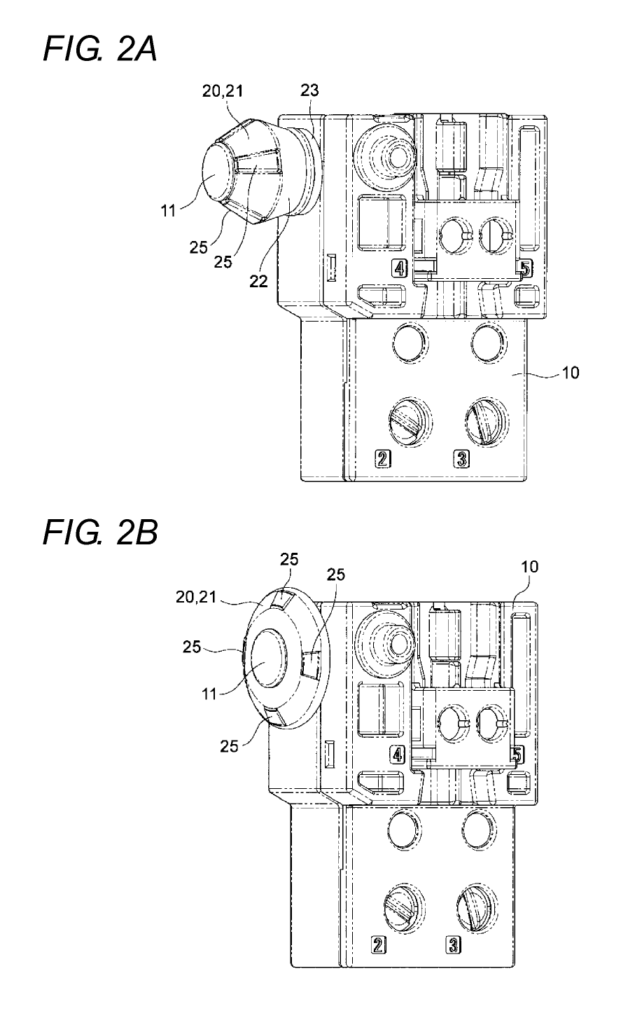

A first embodiment is a dust proof cover 20 for covering an operation shaft 11 with a substantially T shape section attached to a switch main body 10 reciprocably in the axis direction as shown in FIGS. 1A to 4C.

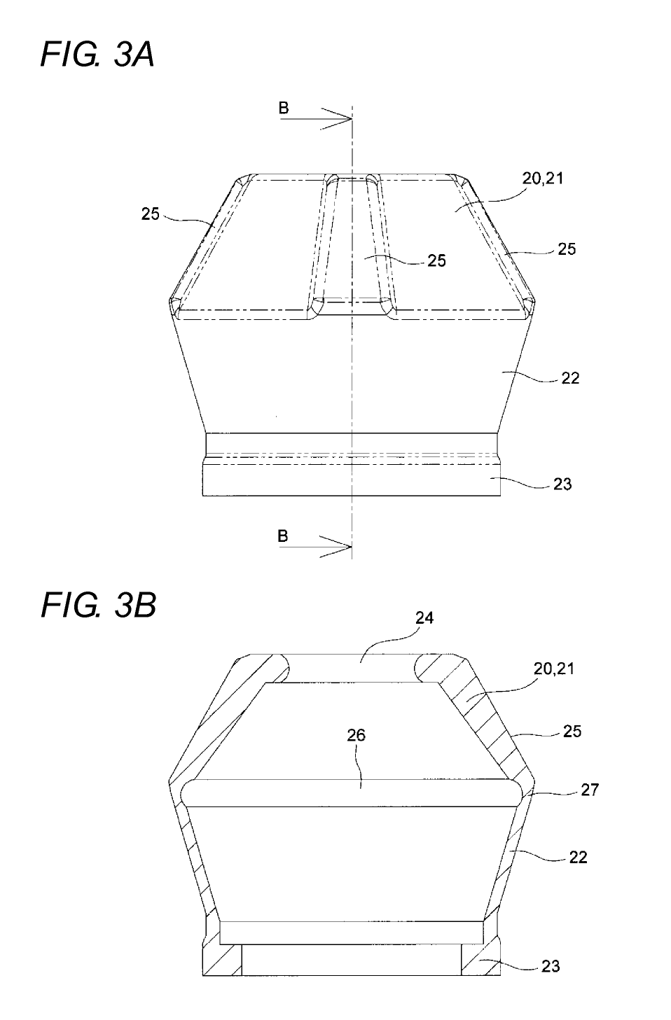

As shown in FIGS. 3A and 3B, the dust proof cover 20 is formed by a thick tubular pressing portion 21 formed into a substantially truncated cone, a thin tubular elastic deformation portion 22 formed into a substantially reversed truncated cone, the tubular elastic deformation portion being continuous with a lower edge of the tubular pressing portion 21, and an annular installment portion 23 continuous with a lower edge of the tubular elastic deformation portion 22.

The tubular pressing portion 21 becomes gradually thinner from an upper end thereof to a lower end, and an operation hole 24 into which the operation shaft 11 can be inserted is provided in center of an upper end surface thereof, while reinforcing ribs 25 are integrally formed at a predetermined pitch on an outer circumferential surface thereof.

The tubular elastic deformation portion 22 is thinner than the tubular pressing portion 21, and by providing an annular groove portion 26 along an edge on the side of the tubular elastic deformation portion 22 placed on an inner circumferential surface in a connection region with the tubular pressing portion 21, a thin portion 27 which is the thinnest part of the cover 20 is formed. The thin portion 27 is provided so as to easily bend the tubular elastic deformation portion 22 inward.

The annular installment portion 23 is elastically deformed and installed so as to be closely attached to an attachment flange (not shown) protruding from a housing of the switch main body 10.

Therefore, the cover 20 is elastically deformed so as to cover the operation shaft 11 with the T shape section attached to the switch main body 10, and the annular installment portion 23 is installed to the attachment flange of the switch main body 10.

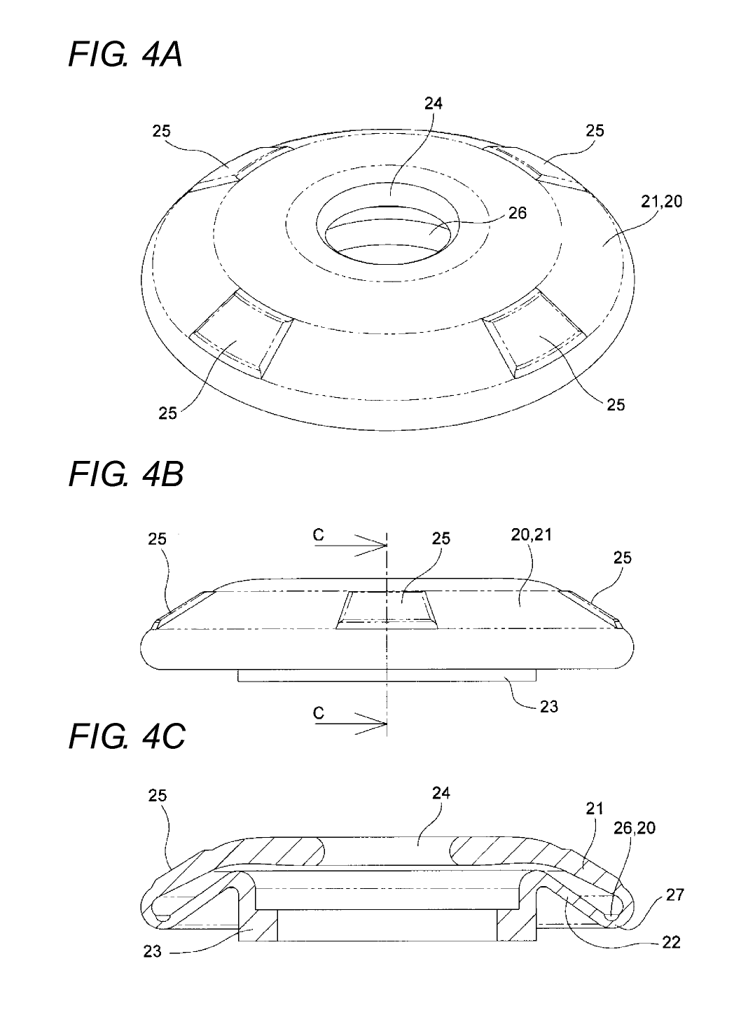

When a front end surface of the operation shaft 11 is pushed down, the tubular pressing portion 21 is pushed down by an action of the operation shaft 11. Then, stress firstly concentrates on the annular groove portion 26, so that the thin portion 27 is elastically deformed. Next, the tubular elastic deformation portion 22 is bent inward by a component force of a push-down force. Therefore, an outer circumferential edge of the tubular pressing portion 21 is not warped, and the entire cover 20 is compactly compressed (refer to FIGS. 4A to 4C). As a result, the outer circumferential edge of the tubular pressing portion 21 is not easily worn out or damaged, so that the long-life cover 20 can be obtained.

It should be noted that in the present embodiment, the cover 20 does not always require the operation hole 24 but may also cover the front end surface of the operation shaft 11. The reinforcing ribs 25 are not always required but may be provided according to need.

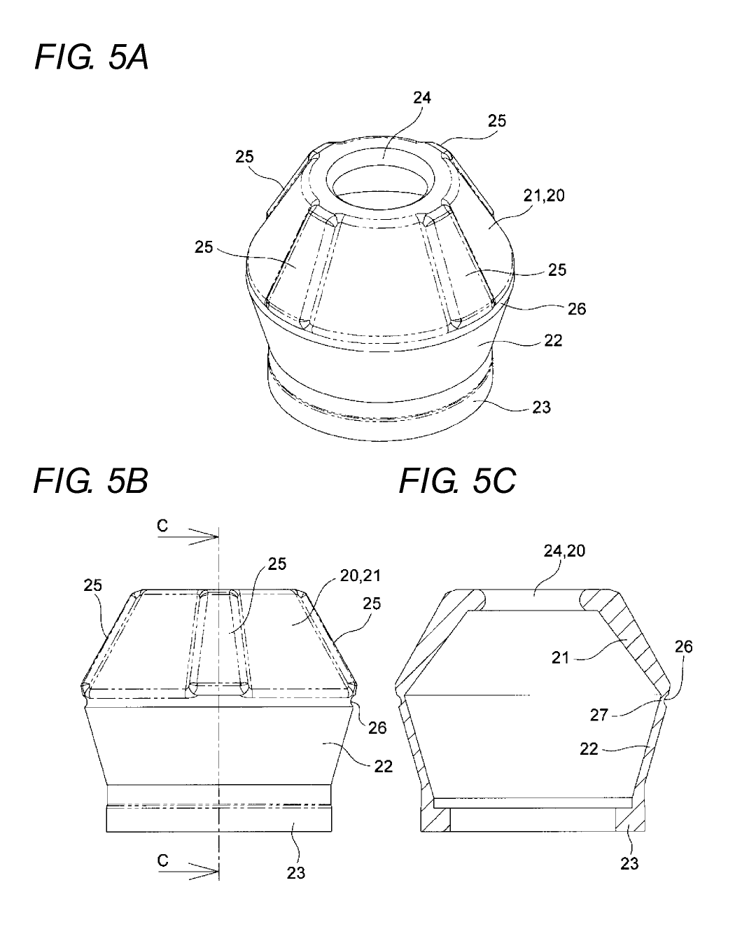

As shown in FIGS. 5A to 5C, a second embodiment is the substantially same as the first embodiment described above. A different point is that the annular groove portion 26 is provided along an edge on the side of the tubular elastic deformation portion 22 placed on an outer circumferential surface in the region where the tubular pressing portion 21 and the tubular elastic deformation portion 22 are connected. Apart from the point, the second embodiment is the same as the first embodiment. Thus, the same parts will be given the same reference numerals and description thereof will not be repeated.

According to the present embodiment, the annular groove portion 26 is formed on the outer circumferential surface. Thus, there is an advantage that a mold is easily manufactured and molding is simply performed.

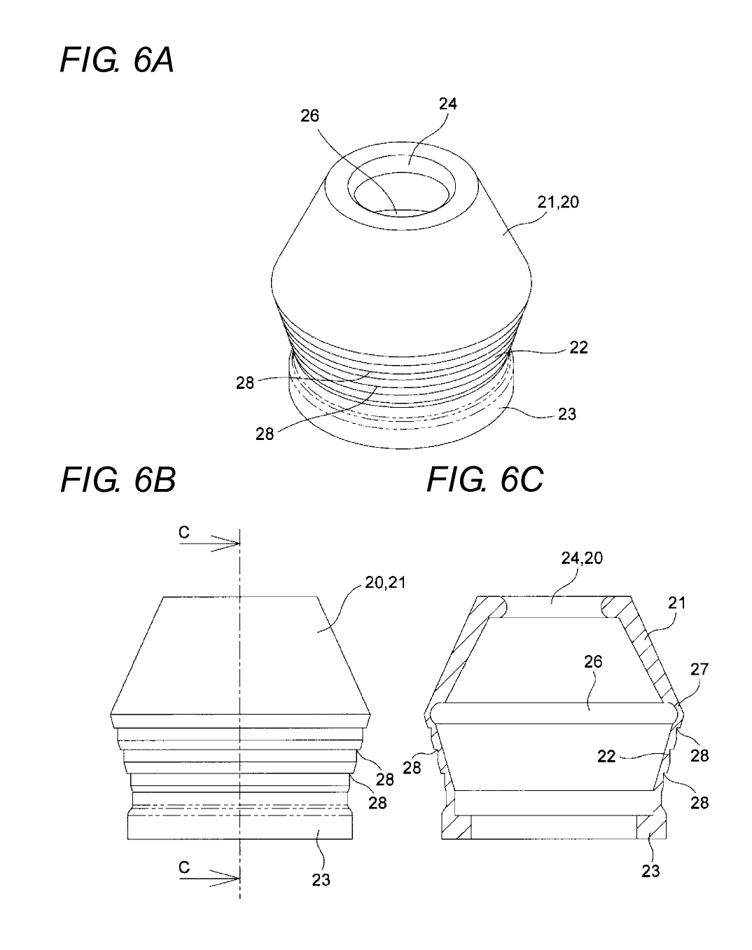

As shown in FIGS. 6A to 6C, a third embodiment is the substantially same as the first embodiment described above. A different point is that no reinforcing ribs are provided on the outer circumferential surface of the tubular pressing portion 21 and the tubular pressing portion is thick and uniform, while annular cutout grooves 28 are provided at a predetermined pitch on the outer circumferential surface of the tubular elastic deformation portion 22. Apart from the point, the third embodiment is the same as the first embodiment. Thus, the same parts will be given the same reference numerals and description thereof will not be repeated.

According to the present embodiment, after the stress concentrates on the thin portion 27 formed by the annular groove portion 26 which is provided on the inner circumferential surface and elastic deformation is started, the tubular elastic deformation portion 22 starts to be further bent inward along the annular cutout grooves 28. Therefore, there is an advantage that the tubular elastic deformation portion 22 is more smoothly deformed along the plurality of annular cutout grooves 28 provided in the tubular elastic deformation portion 22, and operation feel is improved.

It should be noted that the annular cutout grooves 28 may be provided along an inner circumferential surface of the tubular elastic deformation portion 22 as a matter of course.

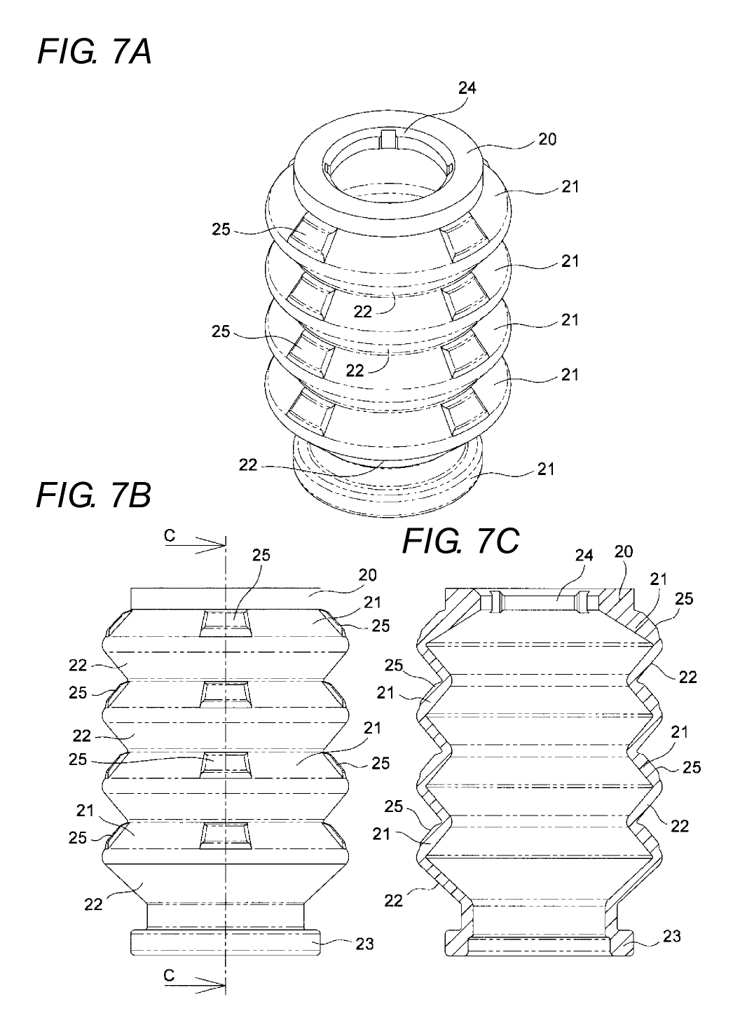

As shown in FIGS. 7A to 7C, a fourth embodiment is a case where a plurality of tubular pressing portions 21 and a plurality of tubular elastic deformation portions 22 are alternately formed in a zigzag shape. The reinforcing ribs 25 are provided at a predetermined pitch on the outer circumferential surface of the tubular pressing portion 21. Apart from the point, the fourth embodiment is the same as the above embodiments. Thus, the same parts will be given the same reference numerals and description thereof will not be repeated.

According to the present embodiment, when the cover 20 of the present embodiment is compressed by the operation shaft (not shown), the thin tubular elastic deformation portions 22 are elastically deformed inward, and the thick tubular pressing portions 21 are deformed so as to be piled on the thick tubular pressing portions 21 placed on the lower side. Therefore, the thin tubular elastic deformation portion 22 is not sandwiched by the thick tubular pressing portions 21, 21. As a result, there is an advantage that an elastic deformation amount of the entire cover 20 can be increased, and the cover applicable to the operation shaft having a large moving distance can be obtained.

In the above embodiments, the cases where the present cover is applied to the dust proof cover of the trigger switch are described. However, the present cover is not limited to this but may be applied to other switches such as a limit switch.

The present cover is not limited to application to the dust proof cover but may be applied to a water proof cover.

Further, the tubular pressing portion formed into a substantially truncated cone or the tubular elastic deformation portion formed into a substantially reversed truncated cone is a concept including six-sided truncated pyramid, eight-sided truncated pyramid, and twelve-sided truncated pyramid portions for example.

The operation shaft is not always required to be exposed from the cover but the entire operation shaft may be covered by the cover.

What is claimed is:

1. A cover for covering an operation shaft protruding from a housing of an electric device and being operable in an axis direction, comprising:
a tubular pressing portion to which a pressing force is applied by operating the operation shaft; and
a tubular elastic deformation portion continuous with a lower edge of an outer circumference of the tubular pressing portion, the tubular elastic deformation portion being thinner than the tubular pressing portion, wherein the tubular elastic deformation portion includes an inner circumferential surface.

2. The cover according to claim 1, wherein
an annular groove portion forming a thin portion is-a thinnest part of the cover is along an edge on a side of the tubular elastic deformation portion in a region where the lower edge of the tubular pressing portion and an upper edge of the tubular elastic deformation portion are connected.

3. The cover according to claim 2, wherein
the annular groove portion forming the thin portion which is the thinnest part of the cover is along the edge on the side of the tubular elastic deformation portion that is on an inner surface in the region where the lower edge of the tubular pressing portion and the upper edge of the tubular elastic deformation portion are connected.

4. The cover according to claim 2, wherein
the annular groove portion forming the thin portion which is the thinnest part of the cover is along the edge on the side of the tubular elastic deformation portion that is on an outer circumferential surface in the region where the lower edge of the tubular pressing portion and the upper edge of the tubular elastic deformation portion are connected.

5. The cover according to claim 1, wherein
at least one annular cutout portion is along an outer circumferential surface of the tubular elastic deformation portion.

6. The cover according to claim 1, wherein
at least one annular cutout portion is along the inner circumferential surface of the tubular elastic deformation portion.

7. The cover according to claim 1, wherein
a plurality of thick tubular pressing portions are formed into a substantially truncated cone and a plurality of thin tubular elastic deformation portions are formed into a substantially reversed truncated cone, the thin tubular elastic deformation portions being continuous with lower edges of outer circumferences of the thick tubular pressing portions that are alternately in a zigzag shape.

8. The cover according to claim 1, wherein
an operation hole from which a front end surface of the operation shaft is exposed is in a center of a front end surface of the tubular pressing portion.

9. A switch including an operation shaft protruding from a housing and being operable in an axis direction, and a cover for covering the operation shaft, wherein
the cover includes a tubular pressing portion to which a pressing force is applied by operating the operation shaft, and a tubular elastic deformation portion continuous to a lower edge of an outer circumference of the tubular pressing portion, the tubular elastic deformation portion being thinner than the tubular pressing portion.
